(19) United States
(12) Patent Application Publication
(10) Pub. No.: US 2018/0123391 A1
(43) Pub. Date: May 3, 2018

(54) System and Method for Dynamic Measurement and Control of Synchronized Remote Energy Resources

(71) Applicants: Brian David LAKAMP, Bedford, NY (US); Robert Frank MARANO, Bedford, NY (US)

(72) Inventors: Brian David LAKAMP, Bedford, NY (US); Robert Frank MARANO, Bedford, NY (US)

(73) Assignee: Totem Power, Inc., Bedford Hills, NY (US)

(21) Appl. No.: 15/797,645

(22) Filed: Oct. 30, 2017

Related U.S. Application Data
(60) Provisional application No. 62/418,221, filed on Nov. 6, 2016.
(60) Provisional application No. 62/414,401, filed on Oct. 28, 2016.

(51) Int. Cl. H02J 13/00; G05B 15/02

(52) U.S. Cl. CPC H02J 13/0096; G05B 15/02

(57) ABSTRACT

A system for dynamically provisioning and/or measuring green power and brown power over an energy provisioning grid and related techniques are described.

### CROSS REFERENCE TO RELATED APPLICATIONS

This application claims the benefit of U.S. Provisional Application No. 62/418,221 filed Nov. 6, 2016 and U.S. Provisional Application No. 62/414,401 filed Oct. 28, 2016 both of which are incorporated herein by reference in their entireties.

### BACKGROUND

As is known in the art, electricity networks can be used to deliver or transport electrical energy power to many participating parties (e.g., houses, etc. . . . ). These electricity networks are typically providing energy from sources that can release unwanted emissions into the environment. (such energy sources are often referred to as “brown energy” sources. Brown energy sources are said to provide brown power). For example, energy sources generated with natural gas, oil and/or coal.

As is also known, there exists a number of different types of energy sources that provide power and do not release unwanted emissions in the environment. Such energy sources are often referred to as “green energy” sources. Green energy sources are said to provide green power which can be made available to loads. Green energy sources include, but are not limited to, devices that convert the wind's kinetic energy into electrical energy (e.g. via wind turbines) and/or devices which use radiant light and heat from the sun to generate power (e.g. solar heating systems, photovoltaics, solar thermal energy systems. The use of wind energy is sometimes referred to as “wind power” and the use radiant light and/or heat from the sun is sometimes referred to as “solar power.”

### SUMMARY

In general, green energy and/or brown energy can be generated and can provide power to one or more loads (e.g., buildings, power storage facilities, houses, electric car chargers, and/or any device that requires power). At each load there can be a dynamic meter (virtual or physical). The meter can measure parameters (e.g., load, weather, etc. . . . ) associated with the power delivery and/or report those measurements to a system for dynamic, real-time measurement and control of energy resources (e.g., sometimes referred to herein as a “data center” or a “demand management controller”) in real-time over a network such as the Internet. The data processing center can assign green power and/or brown power to each of the loads based, at least in part, upon those measurements. The demand management controller includes one or more databases for storage of meter data and other, an energy resource assignment logic processor configured to receive meter data and for processing the meter data provided thereto to generate assignment data, a virtual net demand processor configured to receive assignment data from said energy resource assignment logic processor and in response to such assignment data configured to determine a virtual net demand, a decision parameters processor configured to receive meter data from at least one of said one or more databases and in response thereto to generate one or more decision parameters and a response and balancing logic processor configured to receive one or more decision parameters from said decision parameters processor and a virtual net demand from said virtual net demand processor and in response thereto to issues control signals to control operation of one or more energy assets.

In an embodiment, mappings (i.e. locations of resources) can be generated. Such mappings can be used to create virtual electrical networks and dynamically balance net electrical demand in real-time across distance.

For example, solar generation at a community solar farm might be assigned to a specific user who applies such generation against their energy consumption at home. If such user also has an electric vehicle that charges at the office, all 3 electrical points (home, solar, EV) can be synchronized so that the solar generation is optimally balanced and consumed in real-time by the home loads and the EV.

On a larger scale, the systems and techniques described herein can be deployed to marry generation from multiple sources such as wind and solar plants with multiple loads, energy storage facilities and a fleet of electric vehicles for a government or large corporation with the objective to optimally integrate renewable sources (i.e. green energy sources), thereby increasing, and ideally maximizing, self-consumption and dynamically balancing intermittency.

Both scenarios include techniques that enable broader adoption and proliferation of renewable energy generation on the grid, by reducing the variability presented to the grid operators such as utilities.

The data processing center and/or the meters can be viewed as a system. The system can include deployment of multiple meters and/or multiple data processing centers. The system components can be distributed throughout an electric grid. The components of the system can acquire electrical data points (e.g., data points as needed for determinations of green/brown power, or other parameters as desired) from many points of the electric system. For example, from generation, transmission, distribution to termination points at consumers and businesses, and/or the electric panel installations at the termination points at consumers and businesses.

Each measurement device (e.g., meter) can collect voltage, current, reactive/real/apparent power, and/or energy readings. If a particular device is equipped with physical and/or virtual GPS sensors, the device can also provide data to identify its geolocation. Geolocation can be used in physical mapping of the electric grid, in regards to the physical electric grid transmission/distribution. All such information may be collectively considered to be at least a portion of meter data.

The physical connections between the measuring devices and/or the data sensed at the devices can clearly describe the entry of green and brown electrons into the electric grid. Green power and/or brown power (electricity flows) can then be assigned based upon where they are generated and/or logically consumed throughout the network. In this manner, the accounting of green/brown power can be logically and physically satisfied.

For example, assume a business and a community solar development are electrically coupled to the same physical electric distribution grid. The green power generated at the community solar deployment can be assigned to that business if the system logically makes the assignment. Therefore, the system can perform sensing at each generation and consumption point for an entity on the electric grid. In some instances of the system, the logical assignment can occur across electric grids that are separated physically.

Physical electron pathing can be useful to assist in mapping the topology of sources and sinks of electricity. Such knowledge enables the identification of which sources can physically provide electricity to specific loads. In such a manner, the system can validate a greater accuracy of load and generation accounting and attribution. Topology mapping techniques include pinging between seemingly disconnected nodes, one that generates power and one that consumes a portion of that generated power. Each node can send out an encrypted and unique signal over the electric grid, for which all the other nodes can listen. Each node can also be connected securely to each other over the Internet (an existing and reliable communications network). Every node may share its public key with every other node. As each node records any signals it receives over the grid, it can share the received signal with all the nodes over the secured Internet connection. Since the received signal is encrypted, the receiving node decrypts the signal with the public key from each node to determine from whence the signal arrived. In the course of such mapping, a power generating node can be categorized as either brown or green.

### BRIEF DESCRIPTION OF THE DRAWING

FIG. 1 is block diagram of an illustrative system for dynamically provisioning and/or measuring green power and brown power over an energy provisioning grid;

FIG. 1A is a block diagram of a portion of an example electrical grid having one or more systems for dynamic real-time measurement and control of energy resources coupled thereto;

FIG. 2 is a block diagram of a system (also referred to herein as a “demand management controller” or “data center”) for dynamic, real-time measurement and control of energy resources which may be used in a system for dynamically provisioning and/or measuring green power and brown power over an energy provisioning grid such as that shown in FIG. 1;

FIG. 2A is a flow diagram of a process to dynamically provision energy which may, for example, be performed by a data center such as the data center of FIG. 2;

FIG. 3 is a block diagram illustrating energy resource assignment logic;

FIG. 4 is a flow diagram of a process for balancing and response which may, for example, be performed by a data center such as the data center of FIG. 2;

FIG. 5 is a series of timing plots which illustrate a technique for alignment of data points collected in real-time;

FIG. 6 is a flow diagram of a process for generating a time series of predicted data points;

FIG. 6A is a plot of power (or voltage or current) vs. time illustrating predicted data points;

FIG. 7 is an illustrative interface of a type which may be provided on a mobile device;

FIG. 8 is a block diagram of a system for detecting a set of registered electrical units coupled to an electric circuit;

FIGS. 9-9B illustrate an example of assigned load according to an illustrative assignment logic;

FIGS. 10-10B illustrate an example of the assigned generation for a 5 kW solar array onsite, according to an illustrative assignment logic;

FIGS. 11-11B illustrate an example of assigned generation for a 10 kW remote community solar array, according to an illustrative assignment logic;

FIGS. 12-12B illustrate an example of a net load after an assigned generation such as that shown in FIGS. 10-11B;

FIGS. 13-13B illustrate an example of further assigned generation for a 10 kW offsite wind PPA, according to an illustrative assignment logic;

FIGS. 14-14B illustrate an example of a net load after the assigned generation shown in FIGS. 10-11B and FIGS. 13-13B;

FIGS. 15-15B illustrate an example of an assigned storage charge and discharge for a 15 kWh storage, according to an illustrative assignment logic; and

FIGS. 16-16B illustrate an example of a net load after the assigned generation and storage shown in FIGS. 10-11B, 13-13B and FIGS. 15-15B.

### DETAILED DESCRIPTION

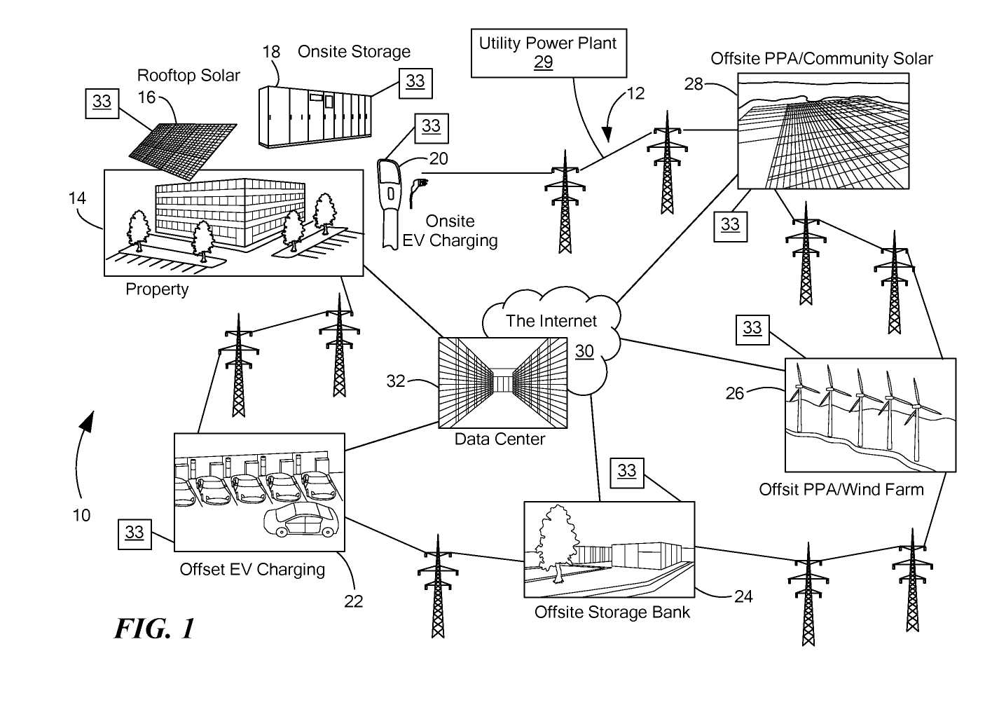

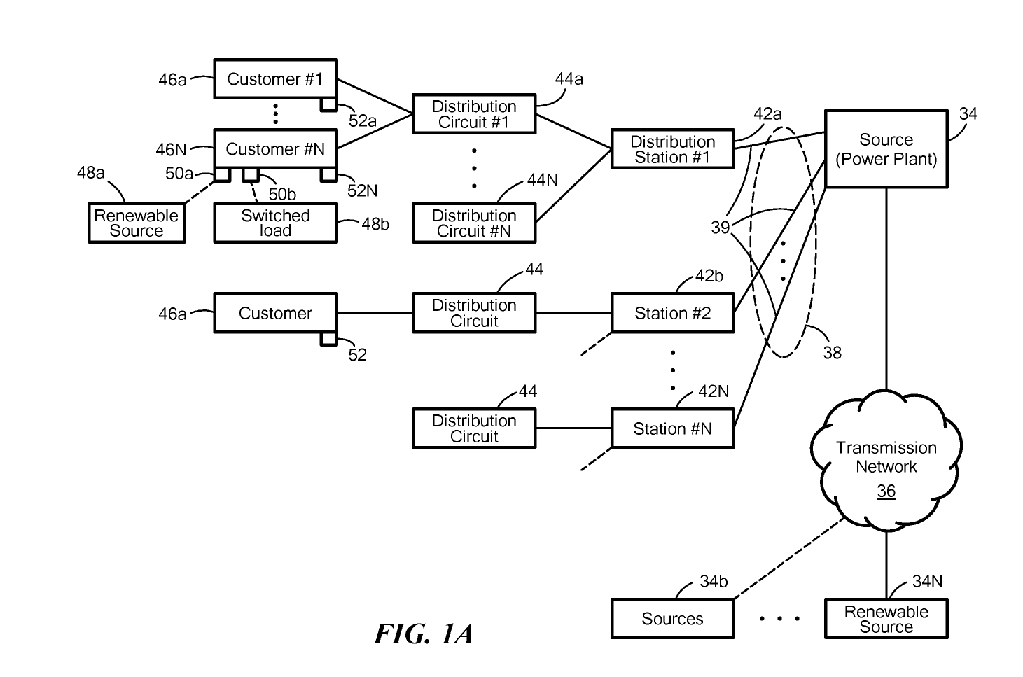

Referring now to FIG. 1, an electrical grid 12 (or more simply “a grid”) formed from a series of electrical transmission lines has multiple assets 14, 22, 24, 26, 28 (e.g., loads, generator and/or storage) in electrical communication therewith. In some instances, an agent may be directly coupled to the grid while in other instances the agents may be coupled to the grid through one or more intermediate devices or systems.

More particularly, the example shown in FIG. 1 shows a grid including a load 14 (e.g., property) that has multiple types of power generation as part of its energy delivery system. The power generation sources of FIG. 1 include roof top solar panels 16, an offsite solar farm 28, an offsite wind farm 26, a utility power plant 29 and an offsite storage bank 24. The offsite storage bank 24 can behave as a load or a generator, and can store and/or supply green power and/or brown power. Storage bank 24 may, for example, be provided as a facility which uses batteries for energy storage sometimes referred to as a battery storage facility, a battery storage power plant or other storage facility.

FIG. 1 also shows that each agent of the grid can communicate with a data center via a communication network 30 (e.g. through a global communication network such as the Internet). Each agent can include a meter 33 (e.g., virtual and/or physical), that can collect and report parameters (e.g. including meter data, energy consumption (i.e. electrical power consumption), energy provided, etc. . . . ) regarding the energy delivery to the data center 32. The data center can use the reported parameters to assign energy to each load, along with predefined rules regarding the energy delivery. The predefined rules (e.g., the property has signed up for power delivery from remote wind farm energy but not remote solar energy, the property has not signed up for any remote green power, etc. . . . ).

Each meter can measure parameters (e.g., energy consumption, energy provided, etc. . . . ) at predetermined time intervals, e.g., 1 second, 5 seconds, 30 seconds, and/or 1 minute (e.g., real-time). In some instances, the predetermined time interval can be based on periodicity of the particular parameter. In some instances, the predetermined time interval can be based on volatility of the particular parameter. In some instances, the predetermined interval can vary over time. For example, the predetermined time interval can be reduced to determine a cause for its change or increased volatility. The measured parameters can be transmitted to the data center via wireless (e.g., via the Internet), wired communication and/or over power lines.

In some instances, if connection to the communication network is lost, each data acquisition device (e.g., meter 33) can store the data locally until connection is restored and/or communicate over a communication path (e.g. a hardline network such and/or a wireless network including not limited to a wireless mesh network) established between each device (e.g., established between multiple meters).

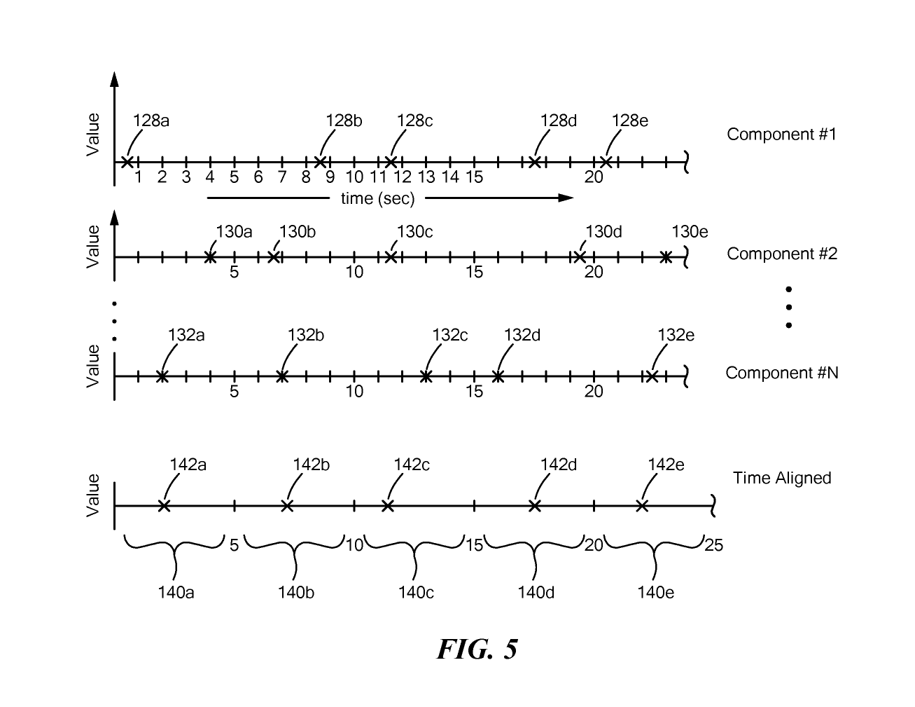

As will be described further below at least in conjunction with FIG. 5, the measurements can be aligned in time against a reference time (e.g., a consistent, accurate moment in time). The time alignment can allow for production of detailed information in real-time of each metered load's usage synchronized across all participating energy contributors.

The data center can determine the assignment of load readings to specific parties based upon a number of models. A load measurement can simply be assigned in whole to a single entity or such load might be partitioned. The partitioning can be based on a percentage basis, time of day basis, and/or absolute prioritized ranges.

In some scenarios, power can be managed for multiple tenants within the same building. For example, assume a building with multiple tenants, A, B and C. Each tenant can create an energy load from their respective use of appliances, such as air conditioners, refrigerators and more. Each tenant's energy use can be sub-metered or assigned logically.

Loads can also be partitioned based on a myriad of different, dynamic bases, including based on one or more variables reported by the meters. For example, the model can assign load based on, user proximity, business relationships, geolocation, weather, energy market rates, seasonality, grid events, commodity futures, other grid participants' behaviors, or any combination thereof.

For example, the load tied to an electric vehicle charging (EV) station in a retail parking lot (e.g. agent 22) can be assigned to a retailer during daytime hours, with assignment on an as-used basis at night to a host of different fleets with agreements to access and/or use the charging station.

In another scenario, a device manufacturer can sell a device with an agreement to pay for all energy consumed by such device, by, for example, accounting dynamically for loads from those distributed devices in a specified territory, accounting for those loads centrally and reconciling against consumers' accounts.

The data center can determine a power delivery requirement for each load (e.g., building, house, electric vehicle power station, etc.) and/or dynamically calculate power generation assignments against each load. Each participating energy asset or resource may have detailed participation/assignment rules by which associated readings may be assigned to the meter. For example, the rules can specify which parameter to capture. A generation measurement can be partitioned on myriad of different bases, including, for example, a percentage basis, time of day basis and/or prioritized absolute ranges. The assignments can be tied to corresponding load(s) and/or or much richer permutations, including other dynamic assignments based on a series of dependencies, conditions and priorities. For example, a particular load can be serviced with dynamic logic that is tied to one or more variables, such as, weather, market prices, other load and Generation variables for other grid participants and/or outages.

The power assignment to a load can be based upon a myriad of different assignment rules. For example, when operating on accordance with one set of assignment rules the system can assign all generation from a particular generation asset, generation from a specific number of solar panels and/or turbines, generation from a source with a specific power rating, prioritized generation from a source with a specific power rating, percentage of total production from a generation source and more.

The assignment rules can also base assignment on a richer set of rules including the utilization of one or more variables reported in real-time by the meter or external data sources. Use of real-time data enables dynamic (or on the fly) decision making with respect to resource assignments. For example, the assignment rules or models can base assignment on load (e.g., power requirement of the one or more loads), its geolocation, weather, energy market rates, seasonality, grid events, commodity futures, other grid participants' behaviors, or any combination thereof.

The assignment models can output an assignment generation value to any of the one or more loads. By applying the assigned generation values against the loads, a real-time net load can be calculated. Based on the net load and/or other variables (e.g., property energy goals, grid events, market rates, weather [current and/or predicted]), energy storage, onsite or offsite, may be deployed to store or discharge energy. By considering net load and battery behavior in real-time a true, managed net load can be calculated. Thus, time specific values can be determined for net demand, green electron export, and brown electron import to determine an amount of green electrons (e.g., the “cleanliness”) of the Property's load coverage at any given moment in time.

The system (or data processing center) 33 can perform data management to align and/or sequence measurement values that are not sufficiently aligned in time sequence, to for example, properly calculate the load coverage. Examples of processing include but are not limited to time-domain and frequency-domain analyses. In some instances, the electrical signals on the grid at each sense point can be analyzed for the types of loads (resistive, capacitive, and/or inductive), and based upon the type, the logic can be altered for most efficient assignment for optimizing any set of particular traits, e.g., most green, most power, etc. In other scenarios, data collected can be stored. For example, if the network may experience outages, technology can be implemented for storing data at collection points and/or forwarding the data to the data center once the Internet connection is re-established. The data processing center can include an ability to combine, recalculate and/or assign values in such error scenarios. Further, in the scenarios where store and/or forward fails or the grid itself is down, the data center can manage and/or handle error processing for scenarios of data loss from a grid agent(s).

The storage facility 24 can logically receive brown and/or green electrons, and a determination of charging via green and/or brown electrons at such storage nodes can include sourcing and/or discharge logic to determine whether discharge events are green or brown electron discharge. Such logic may be FIFO (first in first out), LIFO (last in first out), GOF (green out first) or some other logical means to track and/or determine the energy flows form the energy storage.

For an example of the system described above and assignment of generation and storage against a set of loads, consider the following scenario. Assume three building tenants, A, B and C. They may or may not be sub-metered. For the purposes of this example, assume that these tenants are not sub-metered and load assignment logic dictates assignment of the aggregate load to each of the three tenants. In this example, A, B and C are assigned a daily load with the assumption that each uses a predetermined amount of kilowatts consistently, up to a maximum amount of kilowatts of daytime use. Thereafter, a static amount of remaining load is assigned to C. If load assignment remains thereafter, any remainder is divided across tenants on an assigned percentage basis. By tracking the assignment logic, readings from a single meter on the building can be assigned to A, B and C.

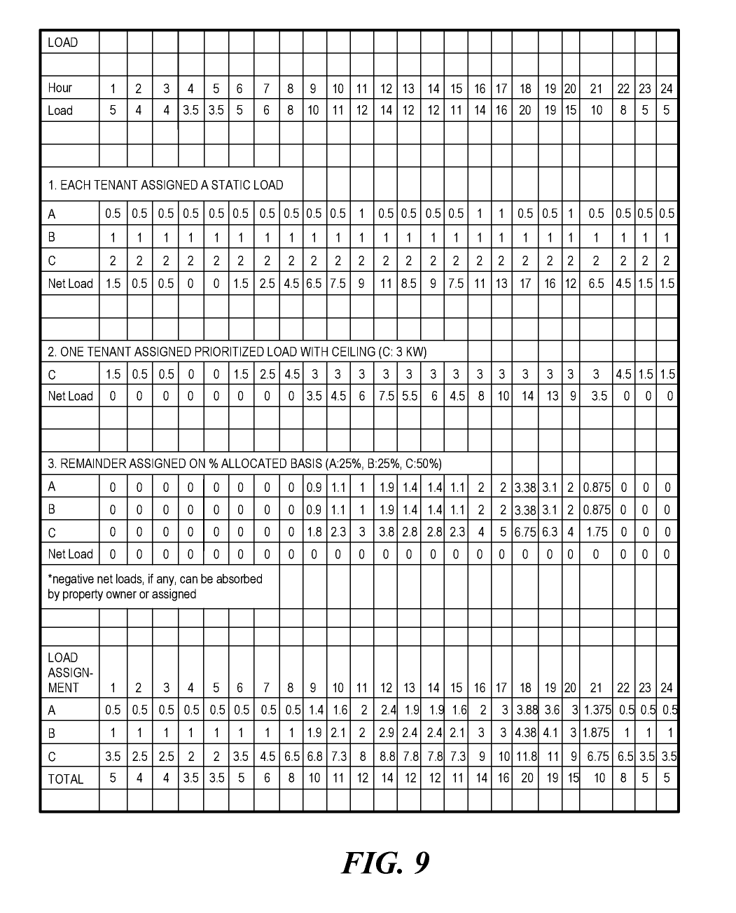

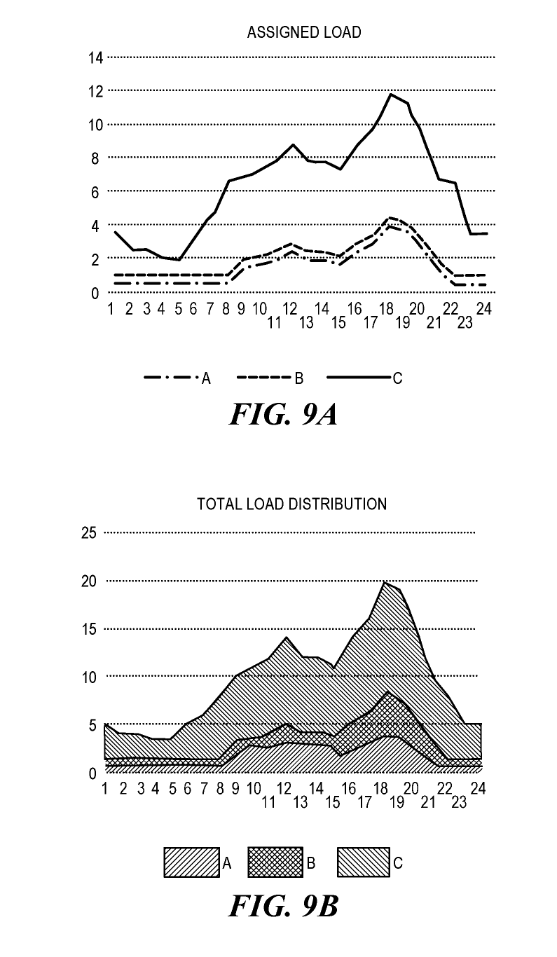

Continuing with the example above, assume that the building owner builds a 5 kW solar array onsite, contracts participation in a 10 kW remote community solar array, and participation in a 10 kW remote wind power purchase agreement (PPA). The building owner contacts A, B and C, who are all interested in using more clean energy. Then, assignment logic is applied to each generation source to partition and assign the produced energy to A, B and, C in real-time. Assume also that the building owner, buys a 15 kW storage array for use of one of the tenants, C, to optimize C's energy use to zero brown electron demand. The various manners in which resources may be assigned in the above scenario are illustrated in FIGS. 9-16B.

Referring now to FIG. 1A a portion of an electrical distribution system which may be the same as or similar to the type described above in conjunction with FIG. 1 includes a plurality of power generation facilities 34 (also sometimes referred to herein as power plants or sources) coupled through an electrical transmission network 36 sometimes referred to herein as a “grid” to one or more distribution stations 42a-42N, generally denoted 42.

Taking power plant 34a as representative of power plants 34b-34N, power plant 34a is coupled through transmission network 38 which may be comprised of a plurality of transmission lines 39 to one or more distribution stations 42a-42N. In turn, each of the stations 42 has one or more distribution circuits 44a-44N coupled thereto. The distribution circuits 44 distribute electrical energy to one or more customers 46a-46N, generally denoted 46.

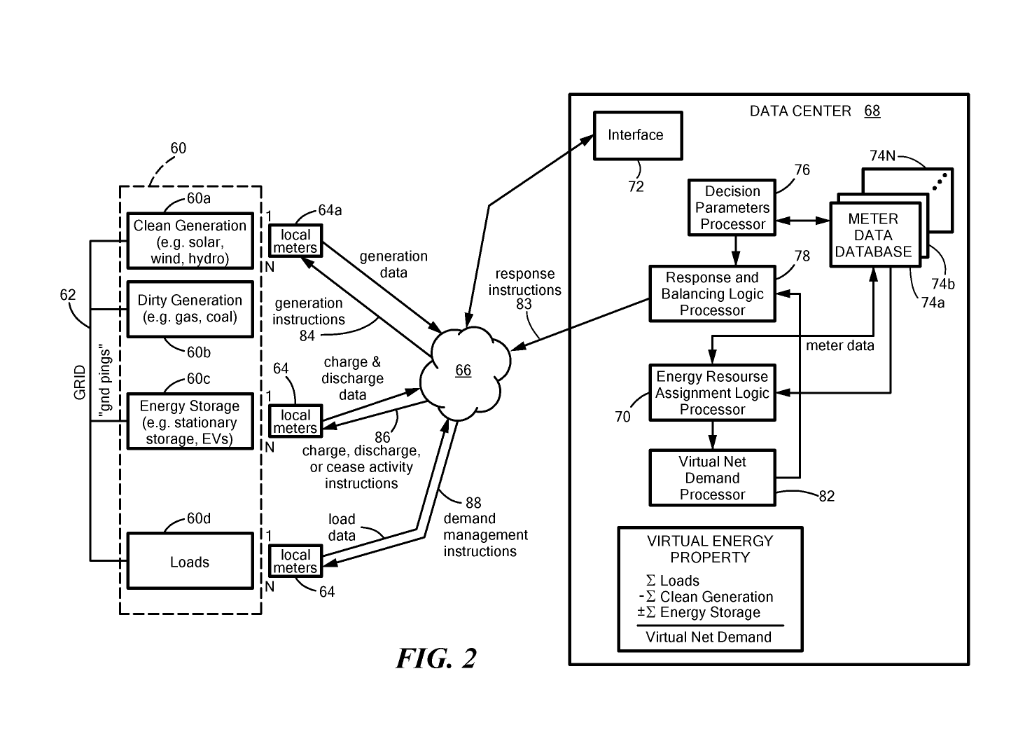

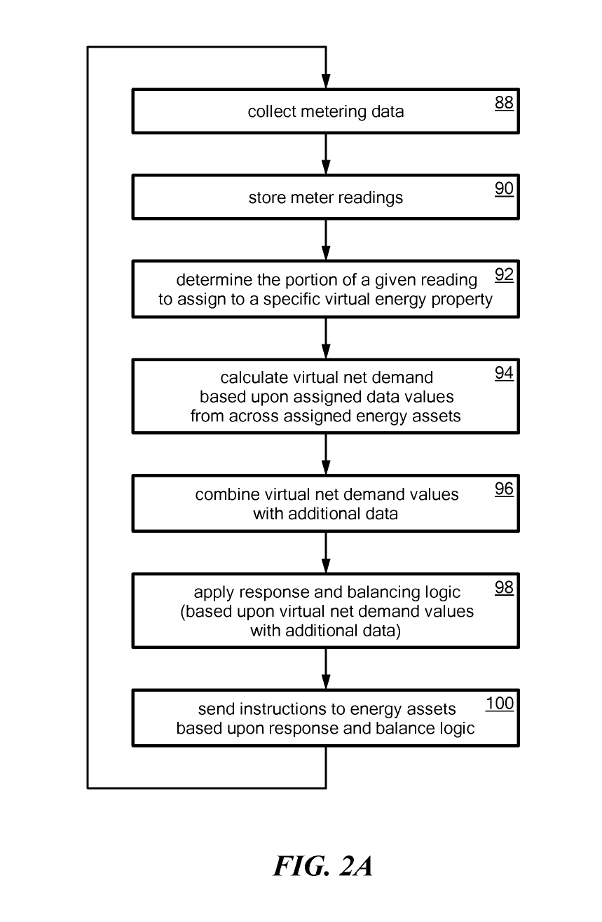

Customers 46 may be commercial customers or residential customers for example customers 46 may be one of agents 14, 22, 24, 28 described above in conjunction with FIG. 1. Each customer 46 may have one or more energy sources 48a (e.g. renewable sources such as roof top solar 16) and/or one or more energy loads 48b (e.g. switchable loads such as EV charging station 20) coupled thereto. The loads and/or sources may be coupled to the customers through switches 50. In some cases, a single switch 50 may be configured such that it may be coupled to both a source and a load. Furthermore, one or more of the customers 46 may include a meter and/or a data center 52. The data center 52 may be the same as or similar to the data center described above in conjunction with FIG. 1 and/or the data center 68 to be described below in conjunction with FIG. 2.

Thus, the data centers 52 may be provided at each customer, or at some customers or on each distribution circuit 44 or on at least some distribution circuits or even at each station 42.

Referring now to FIG. 2 a plurality of energy assets, 60a-60d generally denoted 60, at least some of which have local meters 64 associated therewith are coupled to an electrical grid 62 (e.g. such as a grid established by a distribution circuit 44 as described above in conjunction with FIG. 1A). Energy assets 60 may include, for example, 1-M clean energy sources (including, but not limited to, solar, wind, hydro-energy sources), 1-N energy storage devices (including, but not limited to, stationary storage and electric vehicles) and 1-P loads (including, but not limited to, specific properties and/or specific devices). M, N and P may or may not be the same value (i.e. the number of sources, storage devices and loads may or may not match).

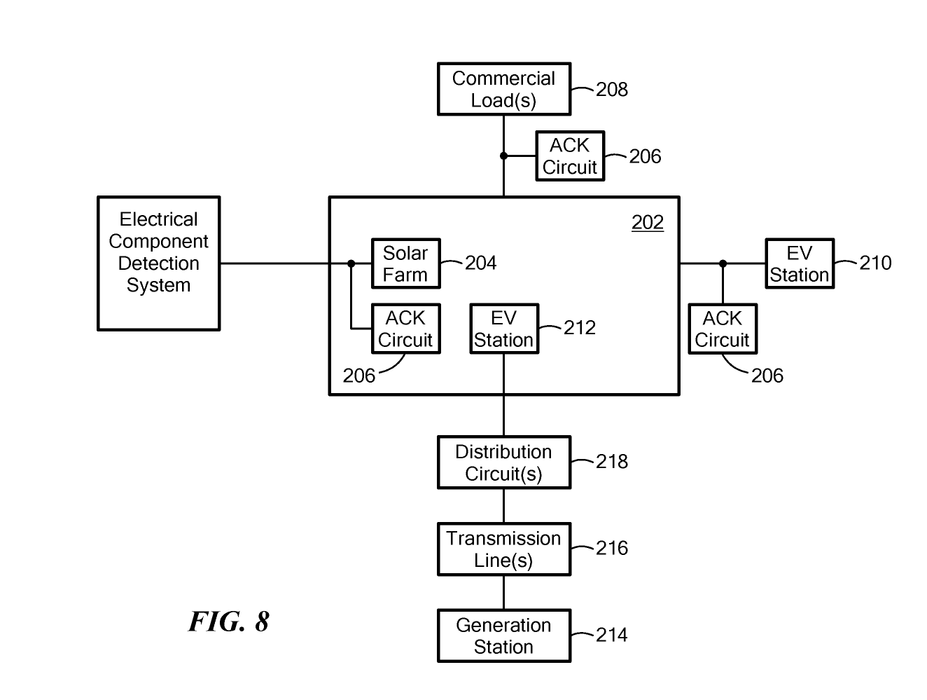

As will be described below in conjunction with FIG. 8, a detection system (or “grid ping” system) may be utilized to assess whether energy assets are visible to one another on circuit 62 and/or if a direct “electron path” exists between any or all of the energy assets 60.

Meters 64 are in communication via a communication network 66 (such as the internet) with a system for dynamic, real-time measurement and control of energy resources 68 (sometimes referred to herein as a “data management controller” or more simply a “data center” 68). As noted above, system 68 may be located at any one of a number of physical locations including customer locations, source and/or load locations, distribution station locations, etc. Local meters 64 may, for example be provided as so-called Totem meters which may be the same as or similar to types described in co-pending application Ser. No. 15/381,460 filed on Dec. 16, 2016 assigned to the assignee of the present application which application is hereby incorporated herein by reference in its entirety.

Local meters may be deployed at any energy asset and metering data may be collected from energy assets 60, via such local meters (e.g. meters 64). The meters capture data and provide (e.g. transmits or otherwise reports) the data to the data center 68. Meter data includes at least a record of consumption of electrical power readings in a given period of time. Meter data may also include electrical power provided to a load in a given period of time, time and date information (i.e. specific days/times during which particular consumption of electrical energy is being measured. Meter data may also include specific location information (i.e. the specific location of the local meter itself and/or the location of the energy asset for which the record of consumption of electrical energy is being generated. (e.g., energy consumption, energy provided, etc. . . . ). In particular, the meter data may be provided to either or both of an energy resource assignment processor 70 and/or one or more data bases 74a-74N. One or more of databases 74 may include, for example, one or more load profiles.

It should be appreciated that in some cases, an energy asset may have a third-party resource utilizing third-party technology which already reports readings (i.e. without having to deploy a dedicated local meter which may, for example, be the same as or similar to the aforementioned Totem meter). It should also be appreciated that data may also be provided to the data center from such third-party resource (e.g. through third-party technology such as a virtual meter). Such data may, for example, be provided to data center 68 through an application programming interface (API) 72. For example, a utility might have an e-meter deployed at various buildings, and the data center may query an online API for access to that data. Thus, although the data is already being captured from another party, the data center may access such data capture via an API. Another example, is smart inverters which monitor/reporting output from certain solar arrays. In such a case. It is not necessary deploy a local Totem meter. Rather the data center can query an online resource (e.g. a third-party resource or other an entity responsible for the smart inverter such as a company which manufactured and/or installed the smart inverter).

Thus, in embodiments, every energy asset in communication (either directly or indirectly) to the data center has a local meter (which may or may not be a Totem meter) or a metering facility supplied by a third-party provider. Such local meters capture and communicate meter data to servers (e.g. offsite servers such as so-called cloud servers) that expose the data via API as virtualized meters to the data center.

Regardless of the manner in which the data is collected and provided to the data center, the data is eventually provided (either directly or indirectly) to energy resource assignment logic processor 70 and/or one or more of the data bases 74a-74N.

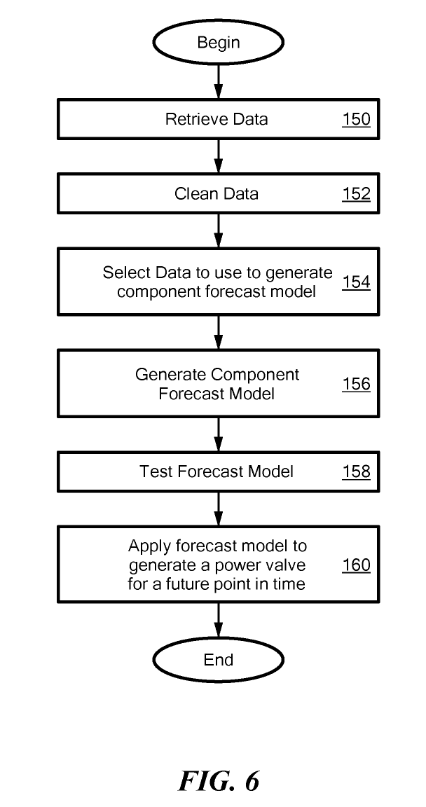

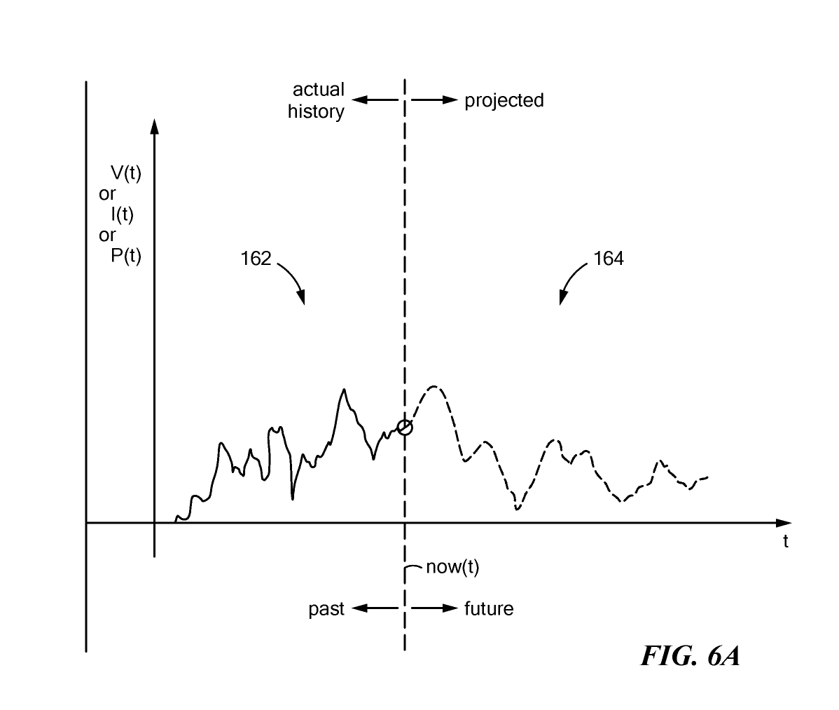

It should be noted that in some cases metering data from virtual meters may be time delayed requiring the use of a data prediction technique such as the technique described below in conjunction with FIG. 6. In some instances, the predicted data is based upon an observed or stored history of data (e.g. data stored in one or more data bases 74a-74N).

Energy resource assignment logic processor 70 receives the data provided thereto (e.g. meter readings or more generally, meter data) and determines assignment data (i.e. a portion of a given reading to assign to a specific virtual energy property). The logic used to determine such assignments may be static or dynamic. For example, in accordance with a static logic process, a predetermined portion may be assigned to the virtual energy property. In accordance with a dynamic logic process, varying portions may be assigned to a virtual energy property based upon a variety of factors or schemes. For example, in some cases a fixed percentage allocation (e.g. a simple percentage allocation such as 10% of a reading), an absolute power allocation (e.g. assign the first 5 kW of a reading) may be used. In some cases, an allocation linked to external factors (e.g. allocation required to synchronize with a remote energy asset's readings). Combinations of such schemes, may of course, also be used.

Other data/factors which may be used for dynamic logic processing by energy resource assignment logic processor 70 include extensive and intensive characteristics/factors which affect the delivery to and the consumption of electricity at a virtual energy property. Such data/factors may, for example, include but are not limited to: a set priority use of electricity (e.g. priority use of electricity for an emergency response); the pricing models employed by the utility for peak demand charges; historical and current weather patterns; and historical and current electricity usage patterns. Each of the above factors/characteristics affects the energy balance within the entire electric circuit of all the participating power sources. Thus, energy resource assignment logic processor 70 receives meter and other data/information provided thereto and in response to some or all of the data provided thereto determines assignment data—i.e. energy resource assignment logic processor 70 determines which energy assets receive and/or provide energy according to a desired scheme (i.e.an energy delivery protocol such as one of the above-identified static or dynamic schemes).

Processor 70 provides data to a virtual net demand process. A virtual net demand processor 82 utilizes data including assignment data (e.g. assigned data values from across assigned energy assets) from energy resource assignment logic processor 70 to compute or otherwise determine virtual net demand based at least upon assigned data values from across assign energy assets. Virtual net demand may be computed, for example, as the sum of load demand less the sum of clean energy generation combined with a sum of energy storage (which may be either a positive or negative value).

Virtual net demand processor 82 computes virtual net demand values and provides such values to a response and balancing logic processor 78.

Data center 68 also includes decision parameters processor 76 which receives decision parameters (e.g. from database 74). Decision parameters include, but are not limited to meter data, weather, market/price signals, scheduled events, and energy asset proximity. The decision parameter processor 76 thus also provides decision parameters to response and balancing logic processor 78.

Response and balancing logic processor 78 receives the data provided thereto from processors 76, 82 and based upon virtual net demand values, paired with additional data (e.g. from the decision parameters processor 76) generates response instructions 83. Response instructions are provided to one or more of the energy assets 60 (e.g. via a corresponding local meter 64). Thus, response and balancing logic processor 78 transmits instructions to energy assets 60 based upon response and balancing logic to perform a variety of tasks including, but not limited to accelerate generation (e.g. hydro); charge, discharge or cease activity instructions to storage assets, and/or send demand management instructions.

For example, response and balancing logic processor 78 may transmit generation instructions 84 to clean generation source 60a via local meter 64a. Similarly, response instructions 83 may result in charge, discharge, or cease activity instructions 86 being provided to an energy storage 60c. Similarly, response and balancing logic processor 78 may provide demand management instructions 88 to one or more loads generally denoted 60d. As will be explained further below, by collecting and processing energy readings in real-time, the data management center 68 is able to synchronize the use of green energy with the generation of power green energy, thereby avoiding the need to use brown energy.

FIGS. 2A, 4 and 6 are a series of flow diagrams which illustrate processing that can be implemented within a system for dynamic measurement and control of synchronized remote energy resources such as that described above in conjunction with FIGS. 1 and 2. Rectangular elements (typified by element 88 in FIG. 2A), are herein denoted “processing blocks” and represent computer software instructions or groups of instructions.

Alternatively, the processing and decision blocks may represent steps performed by functionally equivalent circuits such as a digital signal processor (DSP) circuit or an application specific integrated circuit (ASIC). The flow diagrams do not depict the syntax of any particular programming language but rather illustrate the functional information of one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order.

Referring now to FIG. 2A a flow diagram of a process which may be performed by a data center such as data center 68 described above in conjunction with FIG. 2 begins as shown in processor blocks 88, 90 in which meter data (e.g. meter readings) is collected and stored in a database or processor. Processing then proceeds to processing block 92 in which a determination is made as to what portion of a given reading to assign to a specific virtual energy property.

Processing further includes calculating a virtual net demand based upon assigned data values from across assigned energy assets as shown in processing block 94. Processing then proceeds to processing block 96 where virtual net demand values may be combined with additional data. Such additional data includes, but is not limited to, weather forecasts, scheduled events, energy asset proximity/electron paths and market signals/prices. Such information may be used to initiate response logic across the virtual energy property.

Processing then proceeds to processing block 98 in which response and balancing logic is applied based upon the virtual net demand values and additional data. Processing then proceeds to block 100 where instructions in the form of control signals are sent to energy assets. Such control signals may control the operation of one or more energy assets. For example, a control signal may engage an energy asset (e.g. control the energy asset so as to provide energy to a load or to one or more specific loads). On the other hand, a control signal may disengage an energy asset (e.g. control the energy asset so as to stop or otherwise prevent the energy asset from providing energy to a load or to one or more specific loads). A control signal may control a rate at which an energy asset provides energy to a load or to one or more specific loads. Thus, control signals may control any number of different operations pf an energy asset including, but not limited to engaging, slowing, increasing or disengaging an energy asset. The control signals are based, at least in part, upon response and balance logic.

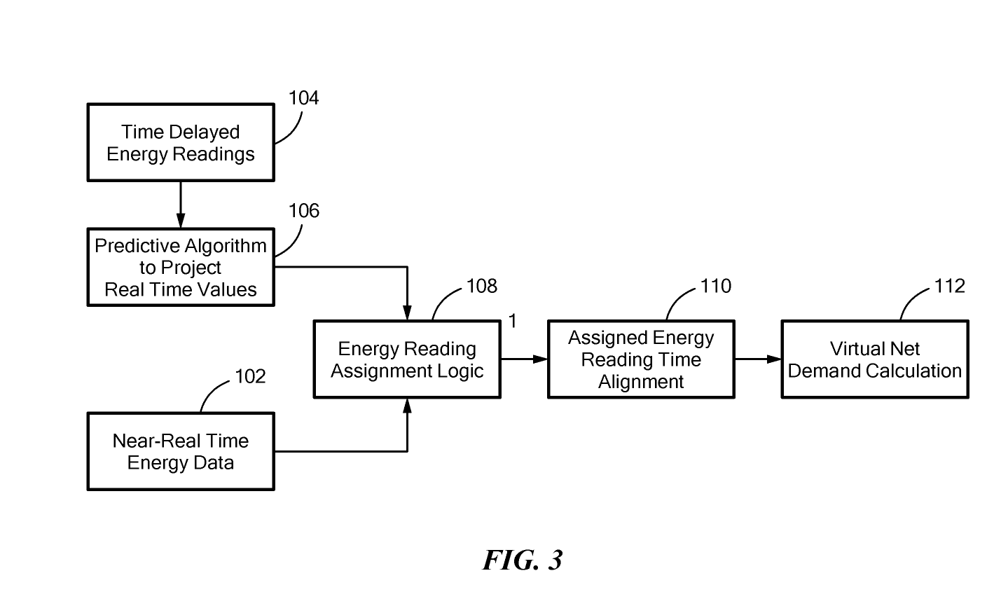

Referring now to FIG. 3, a process for energy resource assignment (e.g. as may be performed, for example, by an energy resource assignment processor (such as an energy resource assignment processor 70 described above in conjunction with FIG. 2).

As shown in processing blocks 102, 108 near real-time energy data may be collected 102 and provided to energy reading assignment logic 108. In some instances, near real-time energy data is collected directly via a network request from local meters or through APIs (e.g. from 3^{rd} parties) on a regular time-delimited basis. In embodiments, data may be collected at regular intervals of time (e.g. every second, every 5 seconds, etc.). The decision as to what time interval to select depends upon a variety of factors, including but not limited to the type of resource being metered, the time of day, time of month, time of year, the existence of extraordinary factors (e.g. extreme weather conditions), variability of market energy prices, unique or dynamic utility requirements. These factors for dynamic logic processing include extensive and intensive characteristics which affect the delivery to and the consumption of electricity at the virtual energy property; for example, the priority use of electricity by emergency response; the pricing models employed by the utility for peak demand charges; historical and current weather patterns; historical and current electricity usage patterns; and much more. Each of these properties affects the energy balance within the entire electric circuit of all the participating resources.

As shown in processing blocks 104, 106, also provided as input to energy reading assignment logic 108 are time delayed energy readings 104 and predicted data values 106.

Time delayed energy readings may be provided by collecting data directly via network request from local meters or APIs (e.g. from 3^{rd} parties) that do not or cannot report in near real time. Such conditions may arise from assets with an irregular network connection (e.g. due to the type of resource being metered, the time of day, time of month, time of year, the existence of extraordinary factors such as extreme weather conditions), third parties reporting on a less frequent schedule (e.g. scheduled daily reporting) or from error scenarios (e.g. due to equipment malfunction or other error scenarios).

For such time-delayed readings, in some cases it may be desirable (or even necessary) to apply predictive logic to generate useful data to provide by the energy reading assignment logic process 108. One technique for predicting such data values is described herein below in conjunction with FIGS. 6 and 6A. In general, a prediction process must be applied to examine the history of prior readings and project a real-time reading based upon past behavior informed by factors such as time of day, day of week, weather and other deterministic criteria.

As shown in processing block 108, all meter readings (i.e. real time, time delayed and predictive) are provided to assignment logic to determine if the reading is 100% assignable to a given virtual energy property or if the energy readings need to be assigned based on some portioning logic. Partitioning scenarios may arise in cases where generation sources are shared such as community solar, where batteries are shared, or where loads are to be shared across a common meter. In some embodiments, the assignment logic may be as simple as a percentage allocation. In other embodiments, dynamic assignments based on conditional priorities and external factors such as weather, season, time of day, load service needs and more may be used. In the case of load service needs, an assignment of energy may be based upon a value from a dynamic load reading.

As noted above, these factors for dynamic logic processing include extensive and intensive characteristics which affect the delivery to and the consumption of electricity at the virtual energy property; for example, the priority use of electricity by emergency response; the pricing models employed by the utility for peak demand charges; historical and current weather patterns; historical and current electricity usage patterns; and much more. Each of these characteristics affects the energy balance within the entire electric circuit of all the participating power sources.

Processing then proceeds to proceeding block 110 where assigned energy reading time alignment is performed. By nature, energy readings will not be perfectly aligned in time and these disparate readings much be synchronized along a common time line to be compared properly. Such alignment occurs by positive or negative offset of the timeline from a given reading to the nearest tick on the shared or common timeline. One illustrative technique for energy reading time alignment is described hereinbelow in conjunction with FIG. 5.

As shown in processing block 112, a virtual net demand calculation is performed by summing time-aligned readings to determine net load, which is equivalent to the required energy from unmetered grid sources, commonly taken to be traditional grid sources (aka brown electrons).

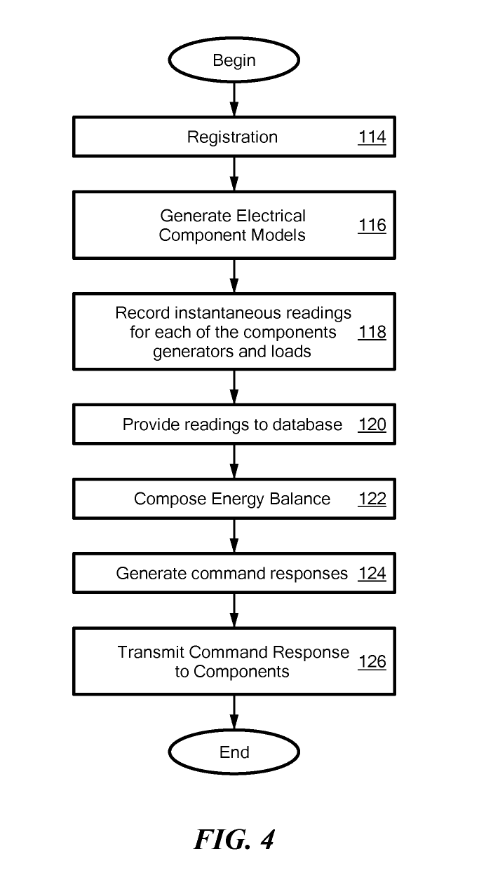

Turning now to FIG. 4, a process for balancing and generating response information (response logic) as may be implemented in response in balancing logic processor 78 described above in conjunction with FIG. 2 will be described. Before describing such a process, however, it should be noted that reference is made hereinbelow to computation of energy balance. It should be understood that the energy balance equation expresses the concept that the sum of all energy sources equals zero at any given moment. The assumption here is that when an electric circuit (e.g. a component) is connected to a utility, the energy balance equation will always “pull” extra power from the utility in order to balance the registered system. In the event the grid is cut off, (i.e. electrical energy can be pulled from the grid) the system will automatically balance the components by storing energy in batteries, providing power to priority loads, or by burning off any excess power via controllable loads, like fans, etc.

Turning now to FIG. 4, a process for balancing and generating response information (response logic) begins in processing block 114 in which a registration process is performed. Registration and availability of data from all registered electrical components, including a priority list for which loads are allowed to be powered with highest priority and for what length of time, and the rating for each priority load is accomplished during the registration process. It should be noted that these registered electrical components are electrically connected, meaning that electricity can physically flow between them. Thus, registration and availability of data from all sources that influence power usage, e.g., weather, utility pricing, etc. is obtained and the information may be stored in a database (e.g. database 74 in FIG. 2) or other storage means. Registration process 114 may also include identification and/or selection of certain configuration parameters (e.g. configuration choice of processing interval times, e.g., every 15 minutes).

Processing then proceeds to processing block 116 in which electrical component models are generated. At the start of every processing interval, the system creates an energy consumption/generation model (i.e. a mathematical model) of each of the registered electrical components. For each component, the energy balance equation is generated and monitored for the entire electric circuit.

In processing block 118 instantaneous readings are recorded for each of the components (generators and loads) registered in processing block 114. During every monitoring time interval, e.g., 5 seconds, the instantaneous readings for each of the component's generators and loads are recorded and made available via a database lookup. Thus, this process may, for example, populate the data use in an energy resource assignment logic processor such as that described above in conjunction with FIG. 2.

Processing then proceeds to processing block 120 in which the instantaneous readings are provided to a data base (such as one of the data bases 74a-74N described above in conjunction with FIG. 2). In an embodiment, on an interrupt basis, for each component, the priority list is loaded and evaluated. If a priority request for power from a registered priority component and there is sufficient power available across registered components (including the grid) in the electric circuit for the priority loads, those loads are powered by a command in the energy resource assignment logic Processor described in conjunction with FIG. 2. If there is not sufficient power available, there is a decision to be made based upon the priority configuration: (a) no priority is given and an alert is sent to the management console that priority cannot be satisfied, or (b) a request is sent to each of the managed components to provide any reserve energy/power to the circuit for priority use in the electric circuit via the energy resource assignment logic processor.

In processing block 122 an energy balance is computed. During each processing interval, e.g., 15 minutes or less, the system, via the “Virtual Net Demand Processor,” calculates the energy balance needed (in the model in step 1) among all the registered electrical components and determines which components can source or sink power for a certain amount of time, based upon predictive models. These predictive models are tuned for each component's cyclic behavior and are generated at least daily with forecasts of what the demand or response would be of the components based upon history and current circuit conditions.

In processing blocks 124, 126 command responses are generated and transmitted to the appropriate components. The calculated energy balance in block 122 produces possible variations in the operating levels of sourcing and sinking of power among the registered components. If permitted by configured priority logic, those variations would require changes to the levels in power consumption or generation in respective components. Once the energy balance equation is evaluated for each of the registered components and subsequently for the managed portion of the electric circuit, each of the calculated variations for the respective components is converted into the respective command responses for each of the components. The command responses are sent via a secure communications network to each respective component.

Referring now to FIG. 5, in general overview, time alignment is a basic service which may be achieved by ensuring that data from a variety of different data sources have synchronized time to a specified time zone (e.g. the UTC time zone). The may be accomplished, for example, using a selected protocol (e.g. an NTP or equivalent protocol). It should be appreciated that time synchronization is a continuous process at each data source.

Once time-stamped data values 128a-128e, 130a-130e, 132a-132e, are collected and universally aligned in time (e.g. using NTP), the time-stamped values are then grouped into time bins (or “buckets”) 140a-140e having a specified width. In the example embodiment of FIG. 5, the bins are provided having a width of five (5) seconds. Other widths (e.g. 10 seconds, 15 seconds, or x seconds) may, of course, also be used. In general, narrower bins are more precise and therefore more valuable to, and responsive for, dynamic decisioning. Ideally, the time bins are the minimum viable size to maximize value. Finer bins (i.e. bins covering a smaller interval of time) provide finer control in time, thus allowing for more “real-time” control to actual usage than working in statistical means for coarser monitoring. Stated differently, once the time stamped data values are synchronized to a desired time zone, the system “buckets” the time stamped data values to a regular time interval, e.g., every 5 seconds, 10 seconds, or x seconds.

Time alignment, or time bucketing, is thus achieved by taking data within an interval, computing an average (i.e. statistical mean) amplitude value in that time interval and assigning the mean value of those components to that time interval. Power measurements are actually instantaneous averages. Time bucketing, therefore, allows for misaligned power readings to be aggregated together and averaged then chopped into time intervals of choice. The sum of power across the time buckets will be the average value in that interval.

For each electrical component, a data acquisition system (e.g. formed by a combination of the meter and data processor hardware and software) is configured to synchronize time using a selected protocol (e.g. the NTP or an equivalent protocol). For each electrical component, for each time interval of resolution, e.g., 5 seconds, the values are fetched. The values are then averaged (i.e. a mean value is computed) and this mean value is then associated to the processed time-series data for that component.

Referring now to FIG. 6 a flow diagram showing a process for predicting data points. In general overview, it should be appreciated that the processing described below (to implement prediction logic) is preferably performed at regular time intervals in order to forecast (e.g. at a desired time interval such as any 5-second time coordinate), the energy flow (power) to/from registered electrical components (e.g. including, but not limited to a generator/solar array, battery storage, load).

The system predicts the next data point after a current time (e.g. time=now) based upon history and other traits that impact electricity usage. These traits influence the electrical components and include but are not limited to weather at the specific geolocation, electric utility pricing for delivery and peak demand charges, etc. The prediction model for each electrical component can be generated daily after the close of each day. Moreover, given more compute and data storage resources, the models can be created hourly, which may not necessarily provide meaningful accuracy. The prediction algorithm uses supervised machine learning techniques like random forests.

As indicated in processing block 150, a process (or logic flow) for calculating the daily model for each electrical component begins with registration of electrical components. During the registration process, electrical characteristics of the electrical components are identified. Also, registration of data sources that represent the influencing traits is performed.

For each future time coordinate requested (now+5 sec, now+10 sec, etc), the machine learning, or prediction, at the end of each day (time zone adjusted) the system loads the history of each of the component's power usage as well as the respective traits aligned to the history's time series. The history span is a configurable term, which is based upon cyclicity of the power usage for each respective electrical component. Time cycles can be daily, weekly, monthly, times per year associated to calendar events and holidays, seasonality like summers and winters, etc. Each electrical components would have associated with it in its database entry what cyclicity it would require for accurate predictions.

As shown in processing block 152, the data is “cleaned.” This may be accomplished, for example, with a prediction algorithm which, for each component, (statistically) cleans the associated and respective data, preparing for calculation of the predicted future time slots (now+5 sec, now+10 sec, etc). This data cleansing removes outliers, data glitches (unrealistic positive and negative power values), etc.

In processing block 154 a selected portion of the data (which may include some or all of the data) is used to generate a component forecast model for each electrical component registered in the system. Based upon the time cyclicity in which the component finds itself at the moment of model generation/training, that amount of data would be loaded into the algorithm execution for that type of or specific instance of the electrical components. With the seasonal data loaded for history and traits, the prediction algorithm produces the component's respective forecast model.

Processing block then proceeds to processing block 156 in which a component forecast model is generated for each desired component.

The forecast model is then tested to ensure integrity and accuracy. This may be accomplished, for example, using associated test data. If the forecast model is deemed accurate then processing proceeds to processing block 160 in which the forecast model is applied to generate power values for future points in time (i.e. the model can be used to forecast the power for the respective electrical component).

Thus, for a current time (now), the model for each electrical component may deliver power values for time in the future (now+5 sec, now+10 sec, etc), that is, given a value of time, the model will produce a power value for that time.

Referring now to FIG. 6A, a plot of past (i.e. measured) values 162 and predicted values 164 is shown.

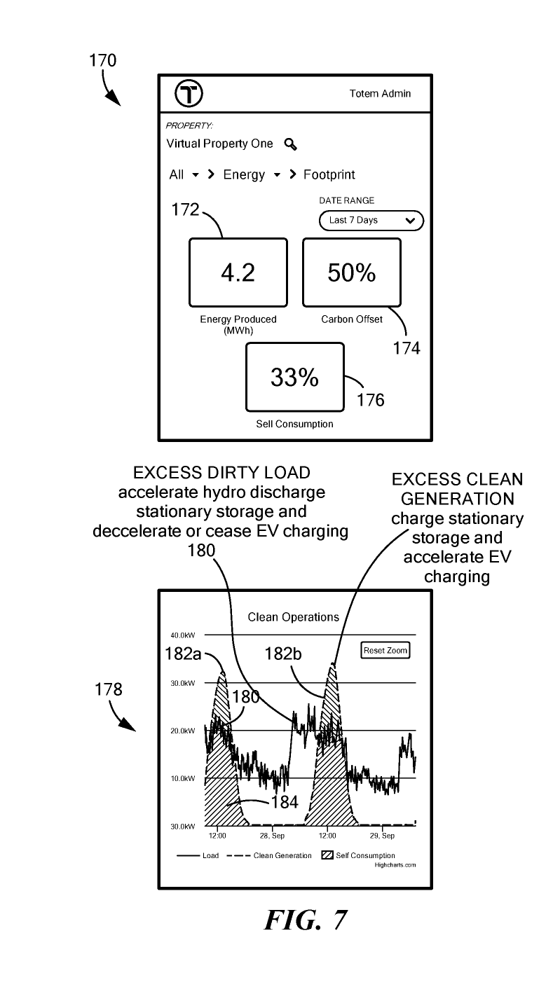

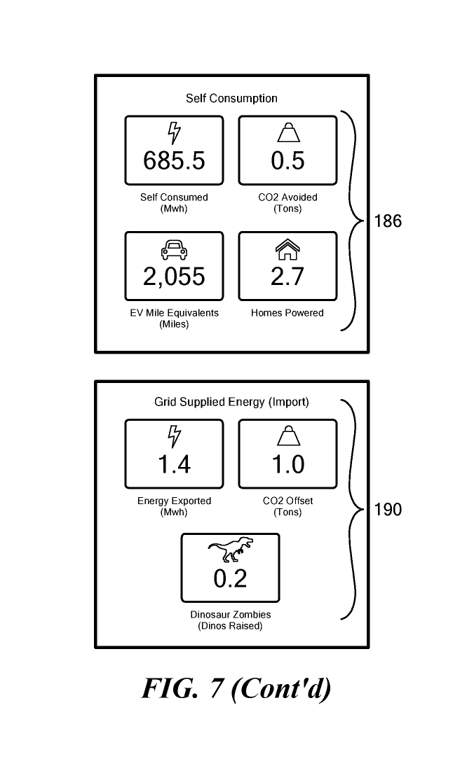

Referring now to FIG. 7 an interface 170, suitable for use on a mobile device for example, includes icons 172, 174 and 176 corresponding to energy produced (in megawatt hours) carbon offset and self-consumption. The interface may also include a plot 178 illustrating load demand 180, clean energy generation 182 and self-consumption 184. Such information is provided to a user on a real-time basis thus allowing a user to make decisions concerning energy usage.

For illustrative purposes, plot 178 shows a simple example involving only a single load and a single solar source (e.g. a roof top solar panel). In this simple example, the regions between curve 180 and peaks 182a, 182b of curve 182 represent excess clean energy generation. Such excess clean energy generation may be used, for example, to charge stationary storage and accelerate EV charging. Other uses are also, of course, possible. Similarly, in the region of plot 178 where curve 180 is above curve 182 (indicating an excess dirty load) it would be possible to accelerate hydro-electric power generation or discharge stationary storage and decelerate or even cease EV charging so as to reduce the need for dirty energy (i.e. so as to reduce the gap between curves 180 and 182.

Thus, using a system for dynamic, real-time measurement and control of energy resources such as system 68 described above in conjunction with FIG. 2) at a time when a home rooftop solar panel is generating excess solar energy (i.e. at least a of curve 182 is above curve 180), the system for dynamic, real-time measurement and control of energy resources may detect the existence of excess green energy and automatically elect to engage a controllable EV charger system so as to choose that particular period of time to charge an electric vehicle. The system thus provides a technique for realizing real-time remote charging synchronization (i.e. the times at which clean energy is used is synchronized to those times when clean energy (e.g. excess clean energy) is available.

Furthermore, the system can control the rate at which the controllable EV charger system charges the electric vehicle. Thus, by collecting and processing energy readings in real-time, the system is able to synchronize the use of green energy with the generation of power green energy, thereby avoiding the need to use brown energy.

Interface 170 may also include icons 186 which indicate self-consumption, icons 188 which indicate excess generation and icons 190 which indicate grid supplied energy.

Referring now to FIG. 8 a system and technique to detect a set of registered electrical units on an electric circuit is shown. An electrical component detection system 200 is coupled to a contiguous electric circuit for grid connections. Connected to circuit 202 may be a plurality of generators and loads. In this illustrative embodiment, a solar farm 204 having an acknowledgment circuit (or more simply “ACK circuit”) 206 is coupled to circuit 202. One or more commercial loads 208 with acknowledgment circuits 206 may be coupled to circuit 202. An EV station 210 with an acknowledgment circuit 206 may be coupled to circuit 202 and an EV station 212 having no acknowledgment circuit, may also be coupled to circuit 202.

It should be appreciated that circuit 202 has electrical energy provided thereto from a generation station 214 coupled to circuit 202 through one or more transmission lines 216 and one or more distribution circuits 218.

The following logic is performed on regular intervals, e.g., once every 30 seconds.

Initially a so-called “ping” public key is registered with each acknowledgement circuit 206 (sometimes referred to herein as a pong unit). In embodiments system 200 distributes the public key in response to a request for the same. In other embodiments, acknowledgement circuit 206 may access a public key (e.g. via a specified URL) or acknowledgement circuits 206 may come pre-loaded with a public key.

Similarly, acknowledgement circuit 206 registers a so-called “pong public key” is registered with the electrical component detection system 200.

System 200 sends an encrypted message via an encoded electrical signal for each ACK circuit 206 registered with system 200. Each message sent by the ping system 200 is unique for each pong circuit on circuit 202. Also, each message contains the source (ping) signal-to-noise ratio (SNR) for the message so as to be used by the receiver (pong) to measure signal loss along the circuit.

The pong circuit decodes each signal within the bandwidth on which it listens and constantly listens for an electrical signal with its encoded message on the electric circuit. Once a “ping” message for the specific pong circuit is found in a signal, the pong circuit will respond with a “pong” message encrypted to the ping circuit including the relative SNR the message had been received.

For each pong response, the ping circuit 200 receives the response message, decodes to ensure the response was meant for the ping circuit, and registers in a database (or other data store) of the ping circuit that the specific pong circuit (or corresponding, managed electric equipment) exists on the electric circuit with relative SNR.

FIGS. 9-9B illustrate an example of assigned load according to the assignment logic shown in the example discussed above (i.e. the example described in conjunction with FIG. 1). In sum, for a 24-hour period, A's load against the grid is a total energy of 34.9 kWh with a peak power of 3.88 kW, B's load against the grid is a total energy of 46.9 kWh with a peak power of 4.38 kW, and C's load against the grid is a total energy of 151 kWh with a peak power of 11.8 k W.

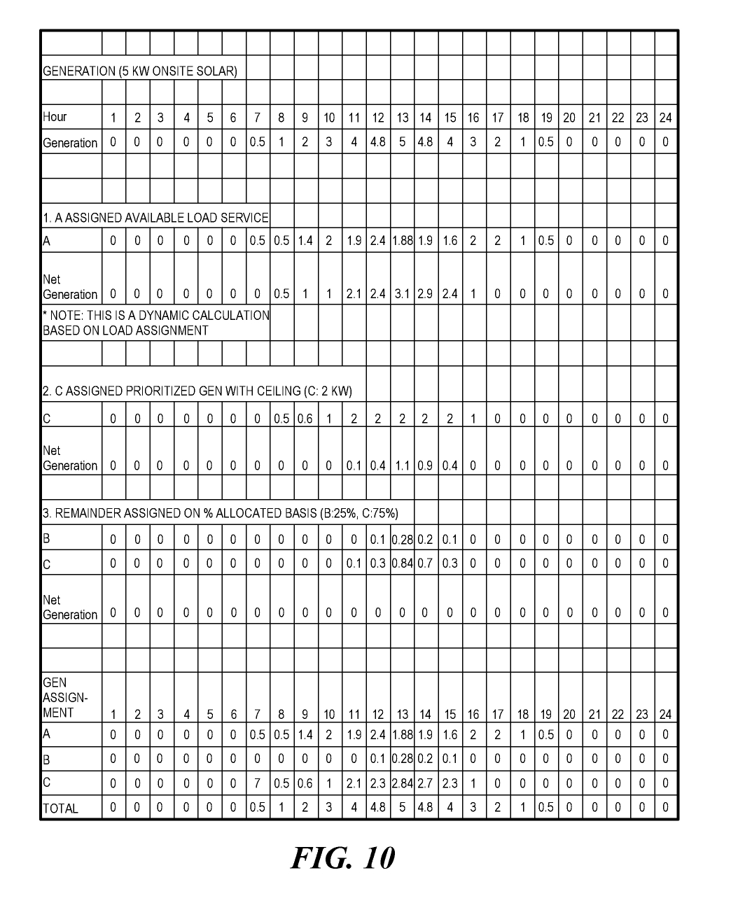

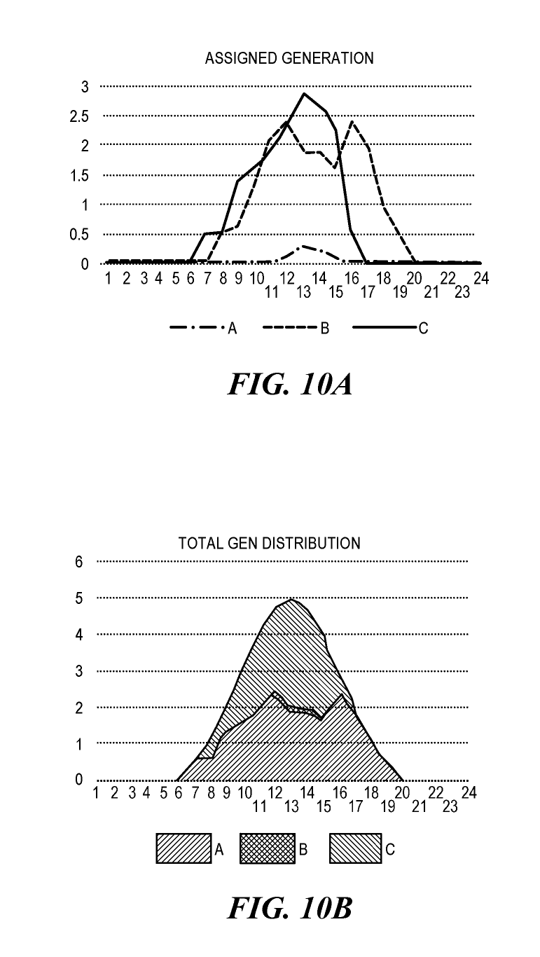

FIGS. 10-10B illustrate an example of the assigned generation for the 5 kW solar array onsite, according to the assignment logic shown in the example above. In sum, for the 24 hour period, the 5 kW onsite solar array provided A a total energy of 19.5 kWh with a peak power of 2.38 kW, B a total energy of 0.72 kWh with a peak power of 0.28 kW, and C a total energy of 15.3 kWh with a peak power of 2.84 kW.

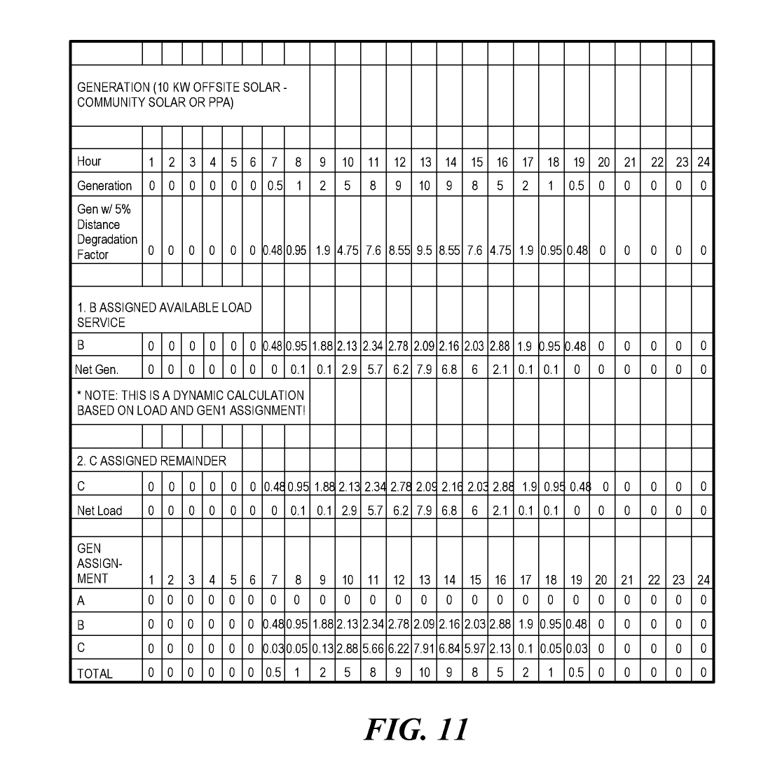

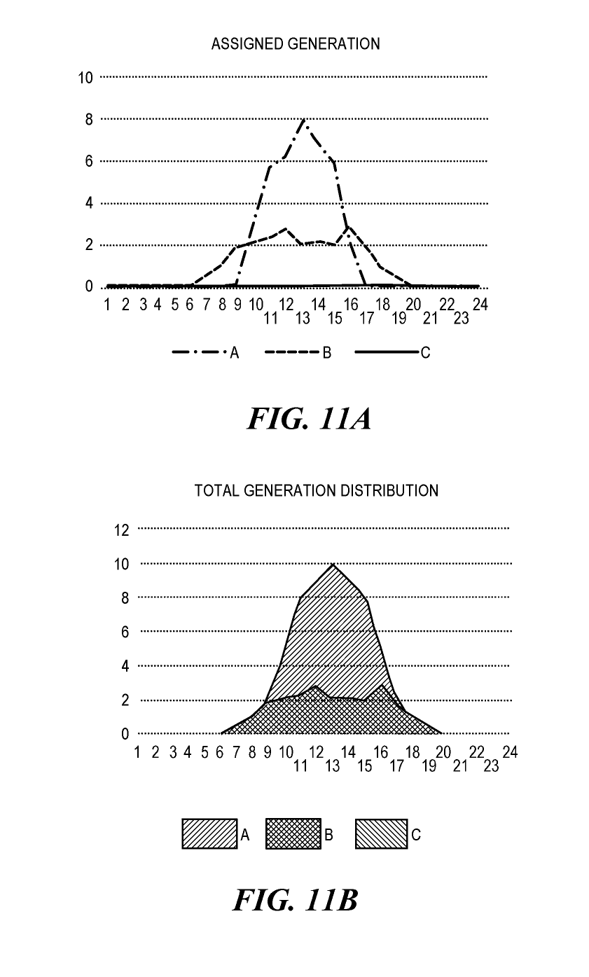

FIGS. 11-11B illustrate an example of the assigned generation for the 10 kW remote community solar array, according to the assignment logic shown in the example above. In sum, for the 24 hour period, the 10 kW remote solar array provided A a total energy of 0.0 kWh with a peak power of 0.0 kW, B a total energy of 23 kWh with a peak power of 2.88 kW, and C a total energy of 38 kWh with a peak power of 7.91 kW.

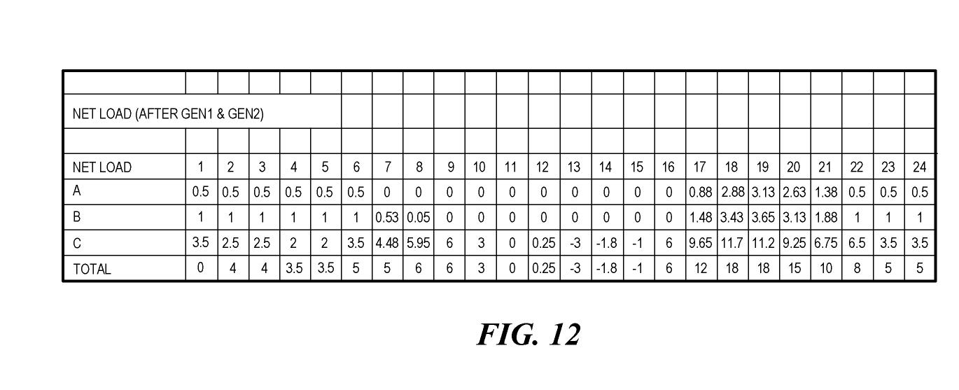

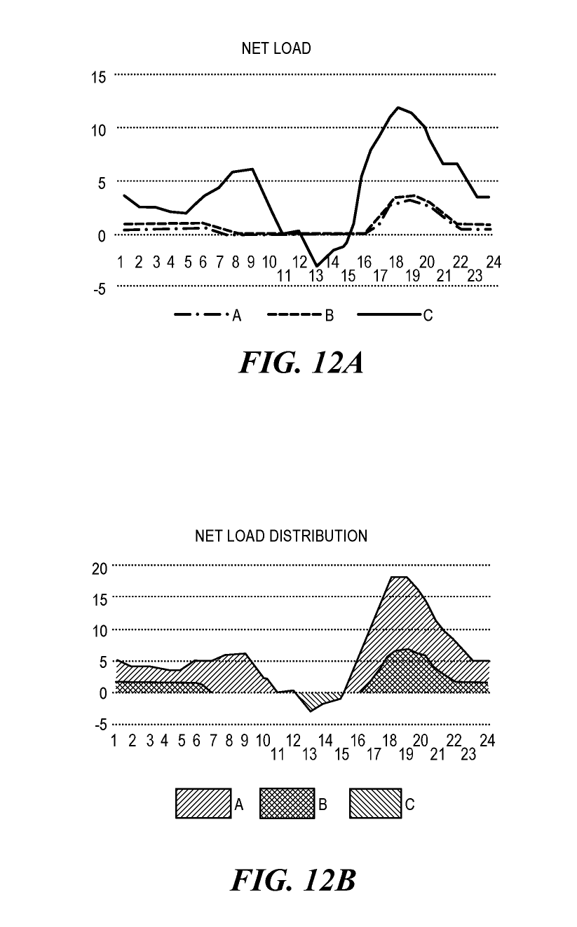

FIGS. 12-12B illustrate an example of a net load after the assigned generation shown in FIGS. 10-11b. In sum, for the 24 hour period, after assigning solar generation and calculating net load for each, A's logical net load against the grid is a total energy of 15.4 kWh with a peak power of 3.13 kW, B's logical net load against the grid is a total energy of 23.1 kWh with a peak power of 3.65 kW, and C's logical net load against the grid is a total energy of 98 kWh with a peak power of 11.7 k W.

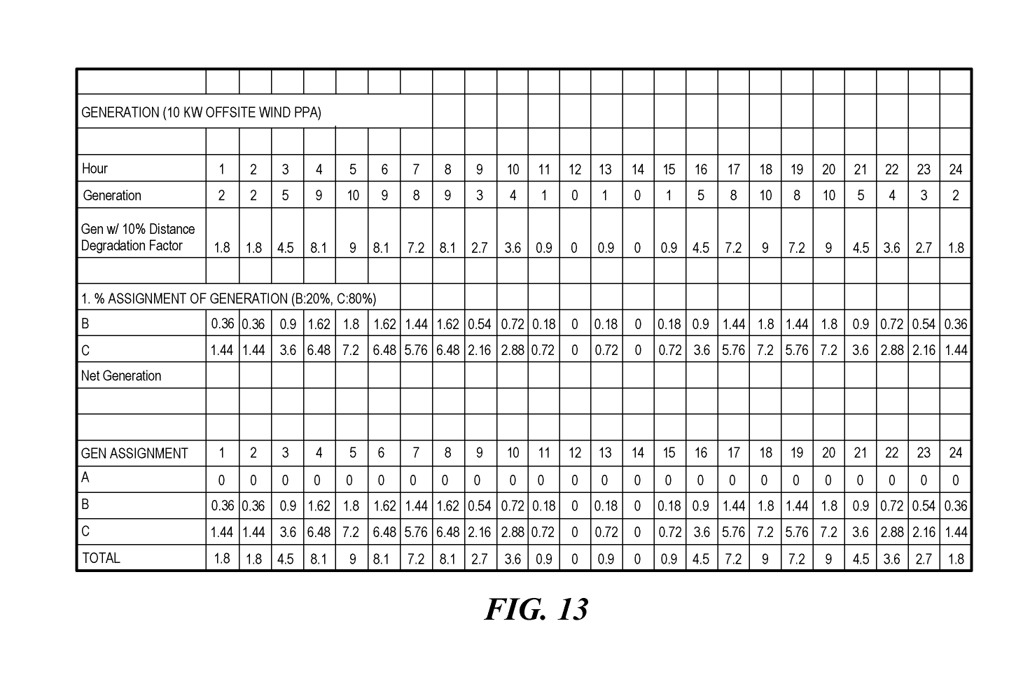

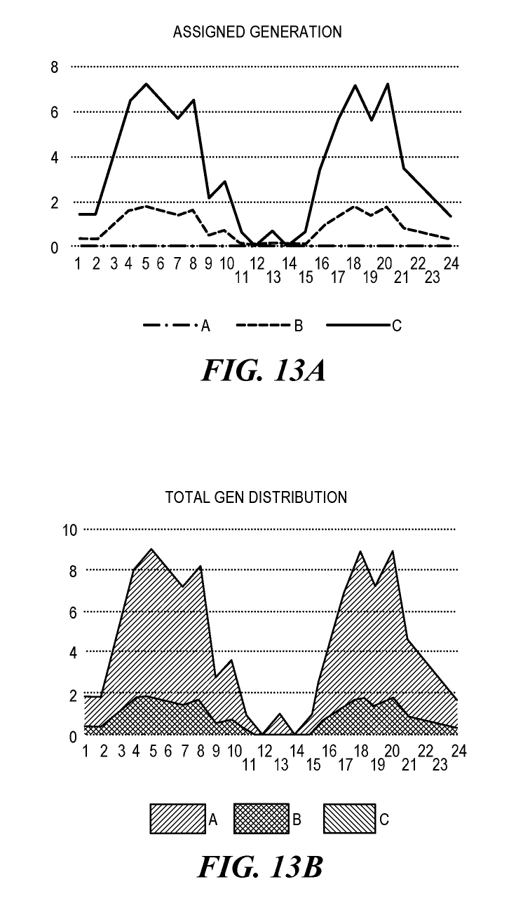

FIGS. 13-13B illustrate an example of further assigned generation for the 10 kW offsite wind PPA, according to the assignment logic shown in the example above. In sum, for the 24 hour period, the 10 kW offsite wind provided A a total energy of 0.0 kW with a peak power of 0.0 kW, B a total energy of 21.4 kW with a peak power of 1.8 kW, and C a total energy of 85.7 k W with a peak power of 7.2 k W.

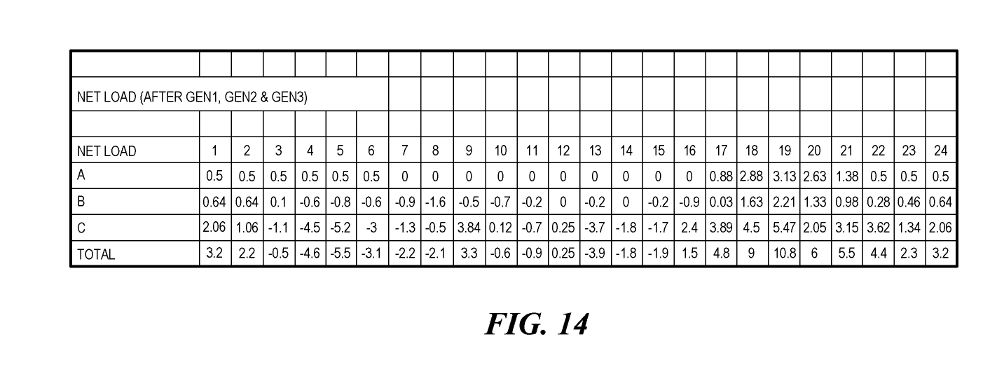

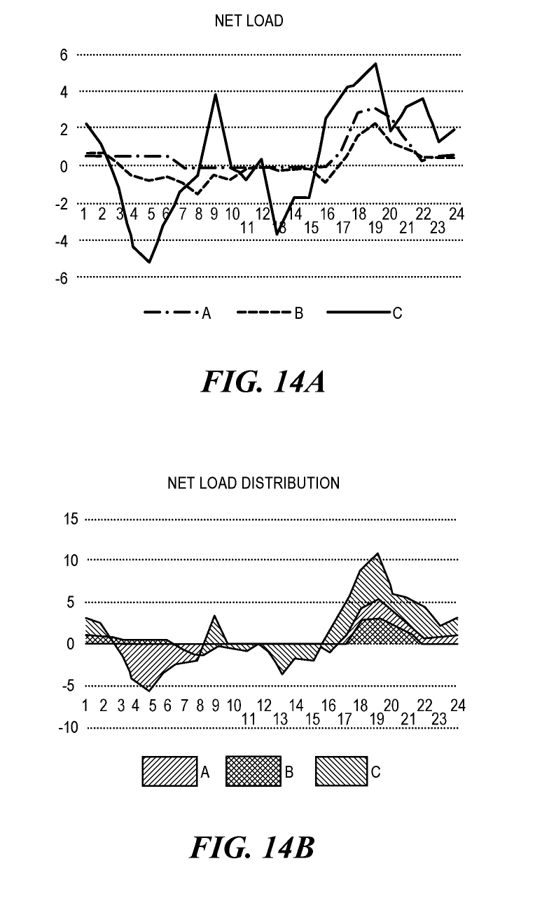

FIGS. 14-14B illustrate an example of a net load after the assigned generation shown in FIGS. 10-11B and 13-13B. In sum, for the 24 hour period, after assigning solar and wind generation and calculating net load for each, A's logical net load against the grid is a total energy of 15.4 kWh with a peak power of 3.13 k W, B's logical net load against the grid is a total energy of 1.71 kWh with a peak power of 2.21 kW, and C's logical net load against the grid is a total energy of 12.3 kWh with a peak power of 5.47 kW.

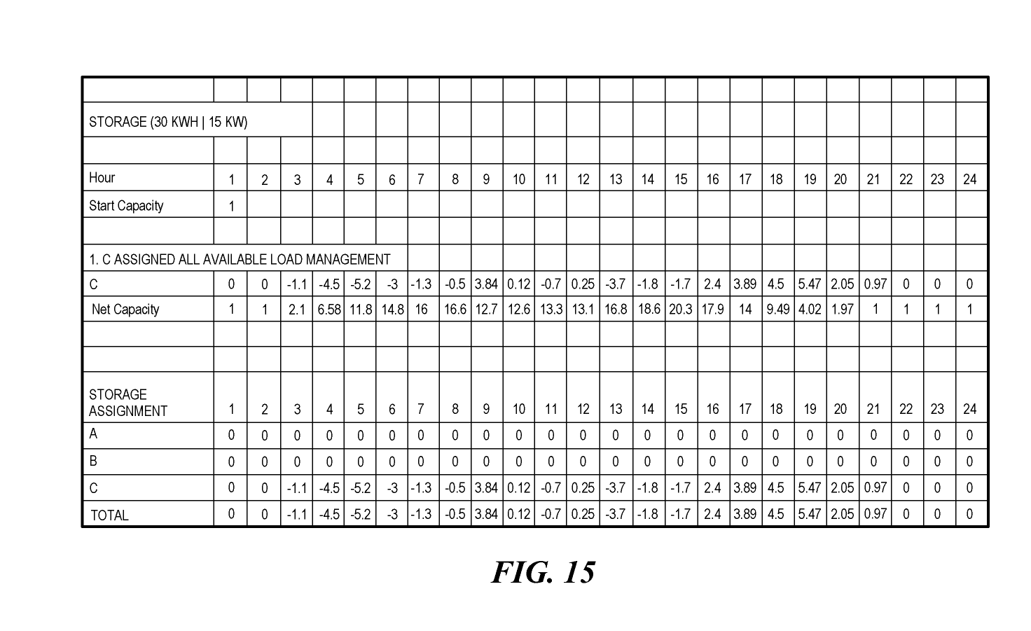

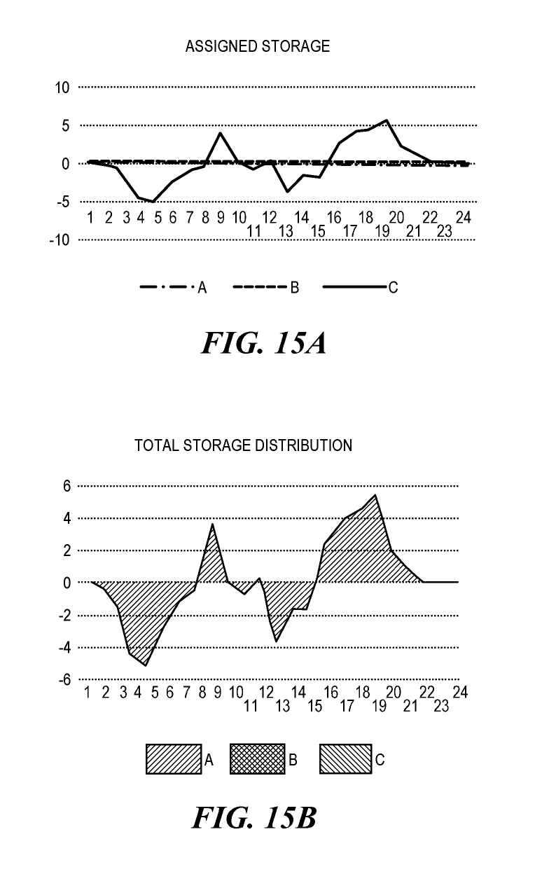

FIGS. 15-15B illustrate an example of the assigned storage charge and discharge for the 15 kWh storage, according to the assignment logic shown in the example above. In sum, for the 24 hour period, the 15 k W storage charged and discharged to provide C a net energy of 0.0 kWh with a peak power of 5.47 kW.

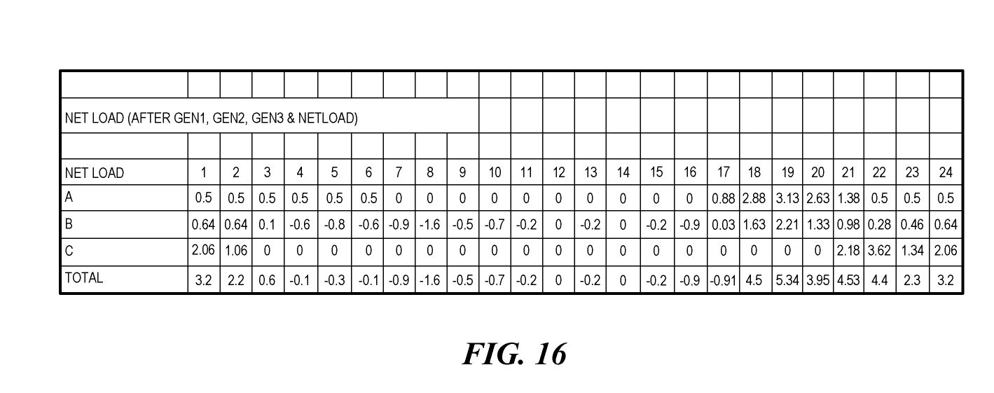

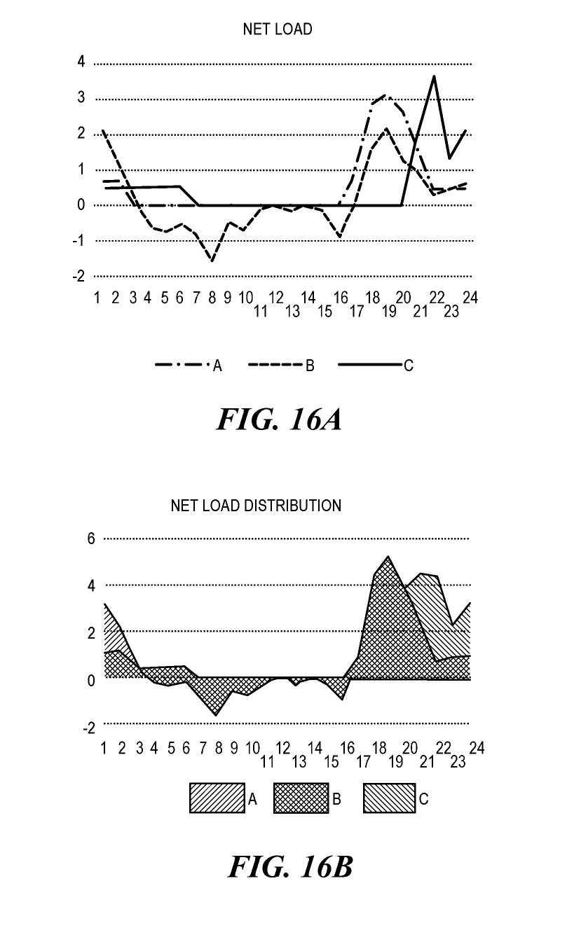

FIGS. 16-16B illustrate an example of a net load after the assigned generation and storage shown in FIGS. 10-11B, 13-13B and 15-15B. In sum, for the 24 hour period, after assigning solar generation, wind generation and storage and calculating net load for each, A's logical net load against the grid is a total energy of 15.4 kWh with a peak power of 3.13 kW, B's logical net load against the grid is a total energy of 1.71 kWh with a peak power of 2.21 kW, and C's logical net load against the grid is had a total energy of 12.3 kWh with a peak power of 3.62 kW.

Tables 1, 2 and 3 show totals for the example described above and illustrated in FIGS. 9-16B.

TABLE 1
ENERGY (KWH)

| | TOTAL | GREEN | NET | CARBON |
|---|---|---|---|---|
| | LOAD | GENERATION | MTR | OFFSET |
| A | 34.9 | 19.5 | 15.4 | 56% |
| B | 46.9 | 45.2 | 1.7 | 96% |
| C | 151.3 | 138.9 | 12.3 | 92% |

TABLE 2
POWER (KW)

| | TOTAL | NET | DEMAND |
|---|---|---|---|
| | DEMAND | DEMAND | SHAVE |
| A | 3.9 | 3.1 | 0.8 |
| B | 4.4 | 2.2 | 2.2 |
| C | 11.8 | 3.6 | 8.1 |

TABLE 3
OPERATIONS (KWH)

| | GREEN | BROWN | CLEAN |
|---|---|---|---|
| | EXPORT | IMPORT | OPERATIONS |
| A | 0.0 | 15.4 | 56% |
| B | 7.2 | 8.9 | 81% |
| C | 0.0 | 12.3 | 92% |

Calculations for the above where:
t indicates a function over time, with t1=starting time and t2=ending time
Greensources is a list of assigned green (non-polluting) generation sources as a function of time to a specific customer, with j=the number of green generation sources
Calculations:
   i. Total Load=Σₜ₌ₜ₁^{t2} Load(t)
   ii. Total Net Load=Σₜ₌ₜ₁^{t2} NetLoad(t)
   iii. Green Power(t)=Σₜ₌₀^{j} Greensourcesₜ
   iv. Total Green Generation=Σₜ₌ₜ₁^{t2} GreenPower(t)
   v. CleanLoad(t)=Min(Load(t),GreenPower(t))
   vi. Total Clean Load=Σₜ₌ₜ₁^{t2} CleanLoad(t)
   vii. BrownLoad(t)=Load(t)−CleanLoad(t)
   viii. Total Brown Load=Σₜ₌ₜ₁^{t2} BrownLoad(t)
   ix.

$$Carbon Offset \% = \frac{Total Green Generation}{Total Load} * 100 \%$$

x.

$$Clean Operations \% = \frac{Total Clean Load}{Total Load} * 100 \%$$

xi. GreenExport(t)=Max((GreenPower(t)−Load(t)),0)
xii. Total Green Export=Σₜ₌ₜ₁^{t2} GreenExport(t)
xiii. Brown Import(t)=Max((Load(t)−GreenPower(t)),0)
xiv. Total Brown Import=Σₜ₌ₜ₁^{t2} BrownImport(t)

In some scenarios A, B and C are independent and geographically separate businesses or residences. In various scenarios, A, B, C have separate meters, or are all connected (or otherwise coupled e.g. via a wired connection, a wireless connection via some combination thereof) to one meter.

Advantages of the concepts, systems and techniques described herein can include, but are not limited to: 1) dynamic calculations of net demand across remote properties; 2) combining remote “community” assets such as community solar and storage into a virtual, dynamically-metered property; 3) providing synchronization/interrelation of remote generation and storage assets for ITC (Incentive Tax Credit) eligibility; and/or 4) assignments of remote loads to parties for rich accounting and/or value attribution around emerging models such as electric vehicle charging infrastructure or charging of a myriad of other devices.

1. A demand management controller comprising:
one or more databases for storage of meter data;
an energy resource assignment logic processor configured to receive meter data and for processing the meter data provided thereto to generate assignment data;
a virtual net demand processor configured to receive assignment data from said energy resource assignment logic processor and in response to such assignment data configured to determine a virtual net demand;
a decision parameters processor configured to receive meter data from at least one of said one or more databases and in response thereto to generate one or more decision parameters;
a response and balancing logic processor configured to receive one or more decision parameters from said decision parameters processor and a virtual net demand from said virtual net demand processor and in response thereto issue one or more control signals to control operation of one or more energy assets.

2. The demand management controller of claim 1 further comprising means for receiving data corresponding from a third-party resource.

3. The demand management controller of claim 1 wherein the one or more databases are configured to store at least one of:
meter data;
one or more load profiles; and
data provided by a third-party resource.

4. The demand management controller of claim 1 wherein said response and balancing logic processor issues one or more control signals to control a switch coupled to at least one an energy asset.

5. The demand management controller of claim 1 wherein said response and balancing logic processor issues one or more control signals to one or more energy assets

6. The demand management controller of claim 1 wherein the one or more energy assets are provided as at least one of:
one or more solar panels;
one or more energy loads;
energy storage assets; and
an electric vehicle (EV) charging station.

7. The demand management controller of claim 1 wherein:
in response to an amount of available clean energy being greater than energy demand by one or more loads, said response and balancing logic processor issues one or more control signals to provide excess clean energy generation to one or more loads; and
in response to an amount of available clean energy being less than energy demand by one or more loads, said response and balancing logic processor issues one or more control signals to reduce or engage energy storage assets to balance an amount of energy available to a load.

8. The demand management controller of claim 1 wherein said energy resource assignment logic processor receives the data provided thereto and determines assignment data using one of: static logic or dynamic logic.

9. The demand management controller of claim 8 wherein said energy resource assignment logic processor uses a dynamic logic process in which varying portions are be assigned to a virtual energy property.

10. The demand management controller of claim 8 wherein said energy resource assignment logic processor determines assignment data based upon one or more of:
a fixed percentage allocation;
an absolute power allocation;
an allocation linked to external factors; and
an allocation required to synchronize with readings from a remote energy asset.

11. The demand management controller of claim 8 wherein said energy resource assignment logic processor determines assignment data based upon one or more of:
extensive and intensive characteristics which affect the delivery to and the consumption of electricity at a virtual energy property;
a set priority use of electricity;
a pricing model employed by a utility for peak demand charges;
historical and current weather patterns; and
historical and current electricity usage patterns.

12. A system for dynamically provisioning and/or measuring green power and brown power over an energy provisioning grid, the system comprising:
(a) an energy provisioning grid comprising;
(a1) an electrical grid;
(a2) a plurality of energy assets in communication with said electrical grid, said plurality of energy assets comprising at least one: of a load, a generator and an energy storage structure with each of said plurality of energy assets configured to collect data and parameters;
(b) a demand management controller comprising:
(b1) one or more databases for storage of meter data;
(b2) an energy resource assignment logic processor configured to receive meter data and for processing the meter data provided thereto to generate assignment data;
(b3) a virtual net demand processor configured to receive assignment data from said energy resource assignment logic processor and in response to such assignment data configured to determine a virtual net demand;
(b4) a decision parameters processor configured to receive meter data from at least one of said one or more databases and in response thereto to generate one or more decision parameters;
(b5) a response and balancing logic processor configured to receive one or more decision parameters from said decision parameters processor and a virtual net demand from said virtual net demand processor and in response thereto to issues control signals to control operation of one or more energy assets.
(c) a communications network coupled to said demand management controller and each of said plurality of energy assets such that each of said plurality of energy assets can communicate with said demand management controller and provide to said demand management controller parameters related to energy delivery and wherein, in response to the meter data provided thereto, said demand management controller assigns energy to each agent in accordance with one or more predefined rules regarding the assignment of energy to each agent.

13. The system of claim 1 wherein the parameters correspond to at least one of:
load characteristics;
weather conditions;
distance;
generation types;
parameters regarding energy delivery to an energy resource; and
energy consumption by an energy resource.

14. The system of claim 12 wherein at least one of said one or more predefined rules comprises at least one of:
assign power from a remote wind energy farm;
assign power from a remote solar farm; and
assign power from a remote storage facility.

15. The system of claim 12 wherein at least one of said plurality of energy agents corresponds to a load with said load comprises an energy delivery system having multiple types of power generation sources provided as part thereof.

16. The system of claim 13 wherein at least one said power generation sources corresponds to one of:
solar panel
offsite solar farm;
an offsite wind farm;
a utility power facility; and
an offsite storage facility.

17. The system of claim 14 wherein said offsite storage plant can behave as a load or a generator and can store and/or supply green power and/or brown power.

18. The system of claim 12 wherein each agent can include a meter (e.g., virtual and/or physical), that can collect and report parameters regarding the energy delivery to the data center.

19. The system of claim 12 wherein said data center can use the reported parameters to assign energy to each load in accordance with one or more predefined rules regarding the energy delivery.

20. A method for dynamically provisioning and/or measuring green power and brown power over an energy provisioning grid, the method comprising:
(a) receiving at a data center a request for energy delivery from one or more loads;
(b) comparing the request for energy delivery to one or more energy delivery protocols associated with each of the one or more loads;
(c) comparing the request for energy delivery to reported parameters associated with each of the one or more loads;
(d) assigning at least one of green power and brown power over the energy provisioning grid to each of the one or more loads in accordance with one or more predefined energy delivery protocols associated with each of the one or more loads regarding the energy delivery.
